(19) United States
(12) Patent Application Publication
(10) Pub. No.: US 2019/0034025 A1
(43) Pub. Date: Jan. 31, 2019

(54) OPERATION TERMINAL INTEGRATED MACHINE OPERATION PANEL AND EXTERNAL DEVICE

(71) Applicant: FANUC CORPORATION, Yamanashi (JP)

(72) Inventors: Ryosuke Izumi, Yamanashi (JP); Shougo Takahashi, Yamanashi (JP)

(73) Assignee: FANUC CORPORATION, Yamanashi (JP)

(21) Appl. No.: 16/046,168

(22) Filed: Jul. 26, 2018

(30) Foreign Application Priority Data
Jul. 31, 2017 (JP) 2017-148016

(51) Int. Cl. G06F 3/041; G09G 5/38; G09G 5/00; G05B 19/042

(52) U.S. Cl. CPC G06F 3/0416; G09G 5/38; G09G 5/006; G05B 2219/23258; G09G 2340/0492; G05B 2219/23377; G05B 19/042

(57) ABSTRACT

A machine operation panel according to an embodiment is a machine operation panel connected to a control device of a machine and configured to operate the control device. The machine operation panel includes: an operation terminal that includes a touch panel for display and input of information and is configured to be portable; and an external device that includes an emergency stop button, an enable switch, and an input device configured to input data to the operation terminal, and is connected to the operation terminal. The operation terminal is attached to the external device such that at least a part of a display region of the touch panel is covered, and at least a part of the input device is provided in a region overlapping the display region.

This application is a new U.S. patent application that claims benefit of JP 2017-148016 filed on Jul. 31, 2017, the content of JP 2017-148016 is incorporated herein by reference.

### BACKGROUND OF THE INVENTION

### 1. Field of the Invention

The present invention relates to an operation terminal integrated-machine operation panel that operates a control device of a machine, and to an external device.

### 2. Description of the Related Art

A portable teaching operation panel connected to a control device of an industrial machine, etc., via wired or wireless communication has been used in order to operate the industrial machine, etc. To date, a portable operation member has been known that includes a holding portion for detachably holding a mobile communication apparatus capable of wireless communication with an industrial machine, a connector connected to the mobile communication apparatus, and an operation section for creating an operation command to the industrial machine, and that transmits the operation command to the industrial machine via the mobile communication apparatus (for example, Japanese Unexamined Patent Publication (Kokai) No. 2015-232804 A).

The machine operation panel is preferably small, because the machine operation panel is operated while being separated from the control device and held by an operator. On the other hand, a terminal having a relatively large screen size, which is typified by a tablet terminal, has become widespread as the mobile communication apparatus. When the tablet terminal is used for programming of application software, data analysis, etc., a larger screen size is more advantageous.

### SUMMARY OF THE INVENTION

However, by integrating the machine operation panel and the tablet terminal together in order to use the tablet terminal as is, as the mobile communication apparatus of the machine operation panel, the size of the machine operation panel increases, thereby resulting in poor operability by an operator.

A machine operation panel according to one aspect of the present disclosure is a machine operation panel connected to a control device of a machine and configured to operate the control device, the machine operation panel including: an operation terminal that includes a touch panel for display and input of information and is configured to be portable; and an external device that includes an emergency stop button, an enable switch, and an input device configured to input data to the operation terminal, the external device being connected to the operation terminal, wherein the operation terminal is attached to the external device such that at least a part of a display region of the touch panel is covered, and wherein at least a part of the input device is provided in a region overlapping the display region.

An external device according to one aspect of the present disclosure is an external device connected to a control device of a machine and configured to operate the control device, the external device including: an emergency stop button configured to stop the control device; an enable switch active during teaching operation of the machine; and an input device configured to input data to an operation terminal, wherein the operation terminal is attached such that at least a part of a display region of the operation terminal is covered, and wherein at least a part of the input device is provided in a region overlapping the display region.

### BRIEF DESCRIPTION OF THE DRAWINGS

The objects, features and advantages of the invention will become more apparent from the following description of the embodiments in connection with the accompanying drawings, wherein:

FIG. 1A is a plan view of a machine operation panel according to a first embodiment before an operation terminal is integrated with an external device;

FIG. 1B is a plan view of the machine operation panel according to the first embodiment after the operation terminal is integrated with the external device;

FIG. 2 is a block diagram of the machine operation panel according to the first embodiment;

FIG. 3 is a block diagram of a machine operation panel according to a second embodiment;

FIG. 4A is a plan view of the machine operation panel according to the second embodiment before an operation terminal is integrated with an external device;

FIG. 4B is a plan view of the machine operation panel according to the second embodiment after the operation terminal is integrated with the external device;

FIG. 5 is a plan view of a machine operation panel according to a third embodiment;

FIG. 6A is a plan view of a machine operation panel according to a fourth embodiment when an operation terminal is inserted from above an external device;

FIG. 6B is a plan view of the machine operation panel according to the fourth embodiment when the operation terminal is inserted from below the external device;

FIG. 7 is a cross-sectional view of the machine operation panel according to the fourth embodiment;

FIG. 8A is a perspective view of the machine operation panel according to the fourth embodiment and of a hollow external device including hinges;

FIG. 8B is a cross-sectional view of the machine operation panel according to the fourth embodiment and of the hollow external device including the hinges;

FIG. 9A is a plan view of a machine operation panel according to a fifth embodiment;

FIG. 9B is a plan view of a machine operation panel according to a modified embodiment of the fifth embodiment; and

FIG. 10 is a perspective view of an external device forming a machine operation panel according to the fifth embodiment.

### DETAILED DESCRIPTION

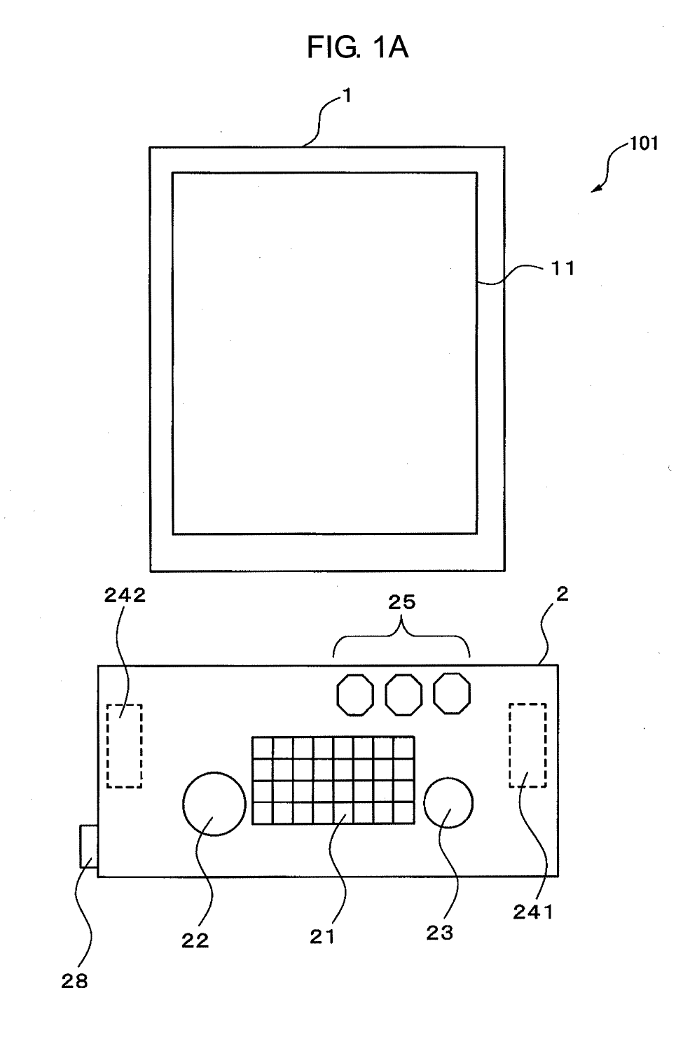

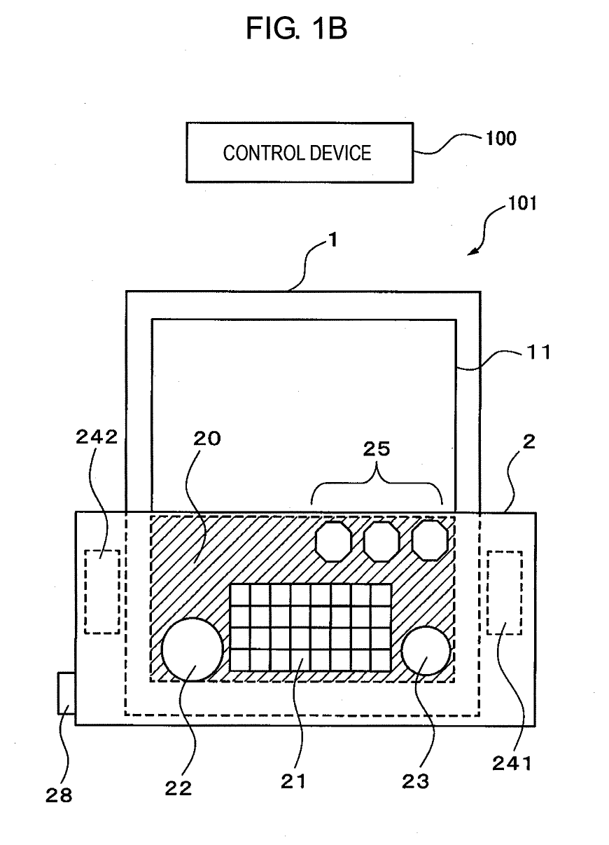

A machine operation panel according to a first embodiment is described. FIG. 1A illustrates a plan view of a machine operation panel before an operation terminal is integrated with an external device, and FIG. 1B illustrates a plan view of the machine operation panel after the operation terminal is integrated with the external device. As illustrated in FIG. 1A, a machine operation panel 101 according to the first embodiment includes an operation terminal 1 and an external device 2. As illustrated in FIG. 1B, the machine operation panel 101 is connected to a control device 100 of a machine (not illustrated) and operates the control device 100. Examples of the machine include a robot, a machine tool, etc., that perform predetermined processing on a workpiece, but are not limited thereto.

The operation terminal 1 includes a touch panel 11 for display and input of information. The operation terminal 1 is preferably portable. For example, a tablet terminal can be used as the operation terminal 1. However, the operation terminal 1 is not limited to this, and a notebook computer including a main body and a display that can be separated from each other can also be used.

The touch panel 11 includes a display device and a position input device disposed on the display device. The size of a display region of the display device is equal to the size of the touch panel. The size of the display region of the display device is preferably about 7 to 15 inches, but may be equal to or less than 7 inches, or equal to or greater than 15 inches. For example, a liquid crystal display device, an organic EL display device, etc., can be used as the display device. An electrostatic capacitance method, a resistance film method, a surface acoustic wave method, etc., can be adopted as a position input method of the position input device. Information can be input to the operation terminal 1 and the operation terminal 1 can be operated by touching the touch panel 11 with a finger or a touch pen.

The external device 2 includes an emergency stop button 23, an enable switch (241, 242), and an input device 21. The emergency stop button 23 is formed as a physical button on the external device 2. In order to compulsorily stop the machine, the emergency stop button 23 is pressed to transmit an emergency stop instruction to the control device, and the machine then stops.

The enable switch (241, 242) is defined as an enabling device in compliance with ISO 10218-2:2011 (E) and used for securing safety of operators, and serves as a switch for teaching operation of a machine only in a case where the enable switch is active. The representative enable switch (241, 242) has a three-position structure as described in Annex C of ISO 10218-1:2011 (E), and allows safety to be ensured by stopping a machine such as a robot when an operator senses danger and releases the switch or presses the switch firmly. The enable switch is effective in ensuring safety when the operator works near a movable section such as a robot arm during teaching of the robot.

Data, text, etc., can be input by operating the input device 21. A keyboard can be provided as the input device 21. However, the input device 21 is not limited to this, and a plurality of buttons may be disposed.

The external device 2 may further include a manual pulse generating device 22. The manual pulse generating device 22 can generate a command pulse by manually rotating a handle. The manual pulse generating device 22 may be displayed on the touch panel 11 and generate a command pulse.

The external device 2 may be provided with one or a plurality of switches 25. Examples of the switch 25 include a start button and a stop button of a program. Lamps may be provided instead of the switch. For example, a blue lamp may be caused to light up during normal operation, and a red lamp may be caused to light up during an abnormal condition. FIGS. 1A and 1B illustrate an embodiment in which the external device 2 is provided with three switches as the switches 25, but the number of switches may be two or less, or four or more.

The external device 2 is preferably provided with an interface 28 for connecting with the control device 100. A USB connector, etc., can be used as the interface (I/F) 28.

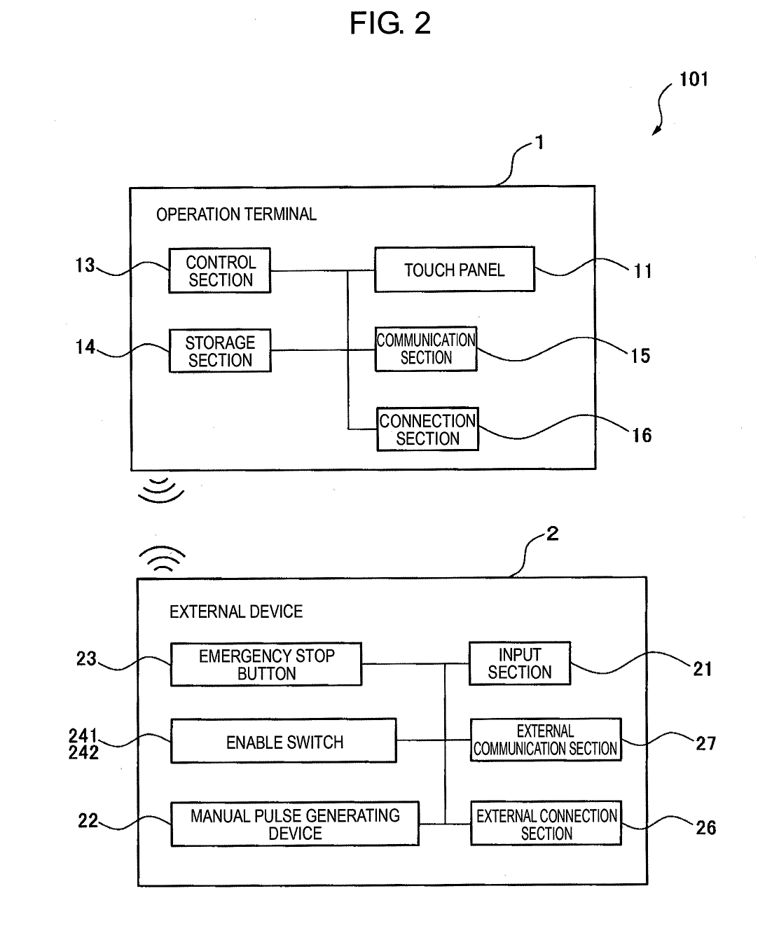

FIG. 2 illustrates a block diagram of the operation terminal 1 and the external device 2 that form the machine operation panel 101. The operation terminal 1 includes the touch panel 11, a controller 13, a storage device 14, a communication device 15, and a connector 16. The operation terminal 1 is connected to the external device 2 in a wired or wireless fashion. The external device 2 can communicate with the control device of the machine in a wired or wireless fashion. The operation terminal 1 can communicate with the control device of the machine via the external device 2 or can be in direct wireless communication with the control device of the machine.

The connector 16 is provided on a base surface, a side surface, or a rear surface of the operation terminal 1 and can be detachably connected to an external connector 26 of the external device 2. A USB connector, a micro USB connector, etc., can be used as the connector 16.

The communication device 15 communicates with an external communication device 27 of the external device 2. Moreover, the communication device 15 can also communicate with a communication device (not illustrated) of the control device.

The touch panel 11 includes the display device and the position input device disposed on the display device. The display device included in the touch panel 11 can display a screen of application software for operating the machine, textual information, etc. The operator touches the position input device of the touch panel 11 to input positional information, and the input positional information is then transmitted to the controller 13.

The controller 13 includes a central processing unit (CPU) and is connected to the touch panel 11, the storage device 14, the communication device 15, and the connector 16. The controller 13 acquires data from the touch panel 11 and the communication device 15, and executes application software, etc., that controls the machine by using information stored in the storage device 14. Further, upon connection of the operation terminal 1 with the external device 2, the controller 13 can detect completion of the connection based on a signal from the connector 16.

A RAM and a ROM built in the operation terminal 1 can be used as the storage device 14 capable of storing the application software that controls the machine, information about control of the machine, etc. Moreover, a memory, etc., connected from the outside can also be used as the storage device 14.

The external device 2 includes the emergency stop button 23, the enable switch (241, 242), the manual pulse generating device 22, the input device 21, the external connector 26, and the external communication device 27.

The external connector 26 is a terminal for connecting with the connector 16 of the operation terminal 1. When the operation terminal 1 is held by the external device 2, the external connector 26 is disposed in a position in contact with the connector 16 or connected to the connector 16 via a cable.

When the operation terminal 1 is connected to the external device 2 in a wireless fashion, data or information input to the input device 21 is transmitted to the communication device 15 of the operation terminal 1 via the external communication device 27. On the other hand, when the operation terminal 1 is connected to the external device 2 in a wired fashion, data or information input to the input device 21 is transmitted to the connector of the operation terminal 1 via the external connector 26. Information from the emergency stop button 23, the enable switch (241, 242), and the manual pulse generating device 22 is transmitted to the control device of the machine from the external communication device 27 or transmitted to the control device of the machine via the communication device 15 of the operation terminal 1.

As illustrated in FIG. 1B, the operation terminal 1 is attached to the external device 2 such that at least a part of the display region of the touch panel 11 is covered. While the operation terminal 1 is attached to the external device 2, a region 20 surrounded by a dotted line in FIG. 1B of the display region of the touch panel 11 is covered by the external device 2.

As a configuration of the external device 2 for holding the operation terminal 1, the external device 2 may have a box-shaped slot. However, the configuration of the external device 2 for holding the operation terminal 1 is not limited to this, and another configuration for fixing the operation terminal 1 may be adopted.

As illustrated in FIG. 1B, at least a part of the input device 21 is provided in the region overlapping the display region. In other words, at least a part of the input device 21 is provided in the region 20 that is a surface of the external device 2 and covers the display region of the touch panel 11. In this way, at least a part of the input device 21 is provided in the region 20, so that size reduction and improved operability of the machine operation panel 101 can be achieved. In other words, when the operation terminal 1 is connected to the external device 2 without covering the display region of the operation terminal 1 by the external device 2, the size of the machine operation panel is inevitably larger than the size of the operation terminal 1. Particularly, in a case where the external device 2 is a multifunctional device including various buttons, an input device, etc., the size of the machine operation panel becomes too large, thereby resulting in loss of ease in holding, which is important for an operation panel. In contrast, in the machine operation panel 101 according to the first embodiment, the entire size of the machine operation panel 101 can be reduced by integrating the external device 2 and the operation terminal 1 such that the external device 2 covers a part of the operation terminal 1 and by further providing at least a part of the input device of the external device 2 in the region 20 covering the display region of the touch panel 11.

An active region usable as the display region of the display device of the operation terminal 1 after the operation terminal 1 is integrated with the external device 2 can be designated by the operator touching the touch panel 11. The active display region that can be visually identified by the operator is reduced by covering a part of the display region of the operation terminal 1 by the external device 2, but when the operation terminal 1 is used as the operation panel, no problem arises because even a relatively small screen for operation is sufficient and a large display region (screen) is not needed.

FIG. 1B illustrates the embodiment in which all of the input device 21 is provided in the region 20, but at least a part of the input device 21 may be provided in the region 20. Moreover, at least one of the manual pulse generating device 22, the emergency stop button 23, or the switches 25 may be disposed so as to overlap the region 20. In this way, the size of the machine operation panel 101 can be further reduced.

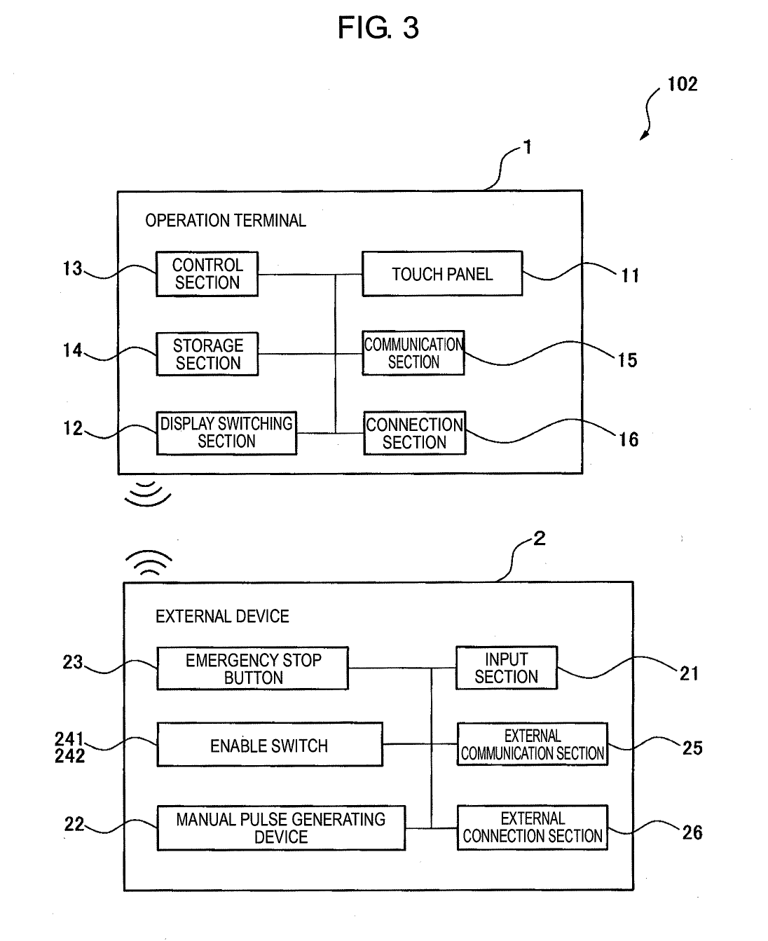

Next, a machine operation panel according to a second embodiment is described. FIG. 3 illustrates a block diagram of a machine operation panel 102 according to the second embodiment. The machine operation panel 102 according to the second embodiment is different from the machine operation panel 101 according to the first embodiment in that the operation terminal 1 further includes a display switching device 12 that switches a screen of the touch panel 11 to a screen for machine operation upon detection of connection with the external device 2. Since the other configuration of the machine operation panel 102 according to the second embodiment is similar to that of the machine operation panel 101 according to the first embodiment, a detailed description thereof is omitted.

When the connector 16 of the operation terminal 1 is connected to the external connector 26 of the external device 2, a signal indicating completion of the connection is transmitted to the display switching device 12. The display switching device 12 transmits a signal to the controller 13 for requesting switching of a display of the touch panel 11. The touch panel 11 switches the screen of the display device based on the signal from the controller 13.

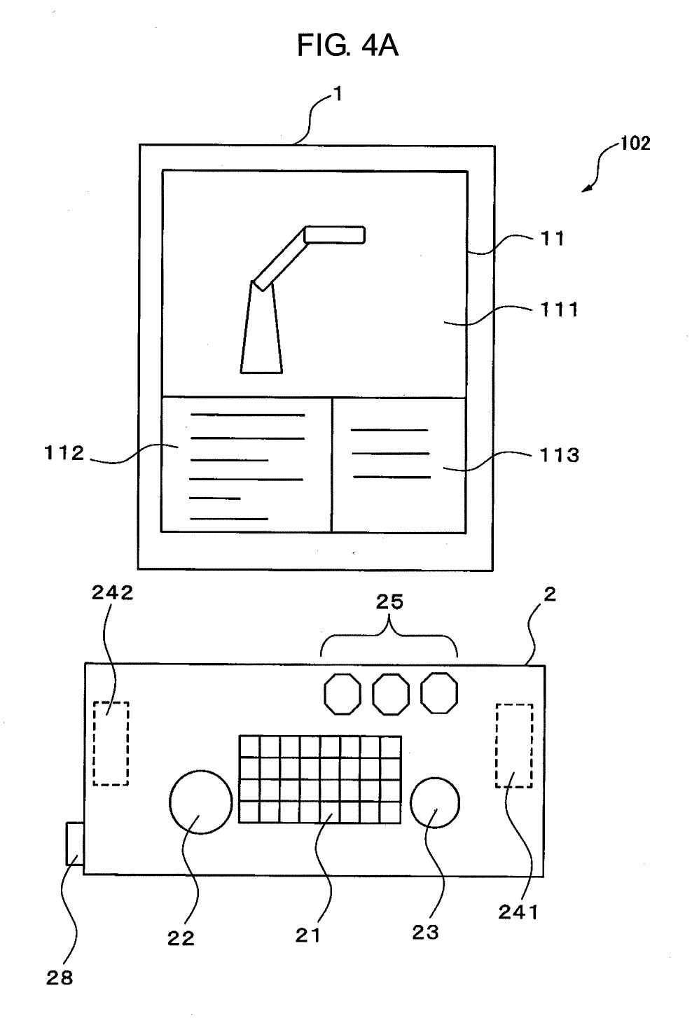

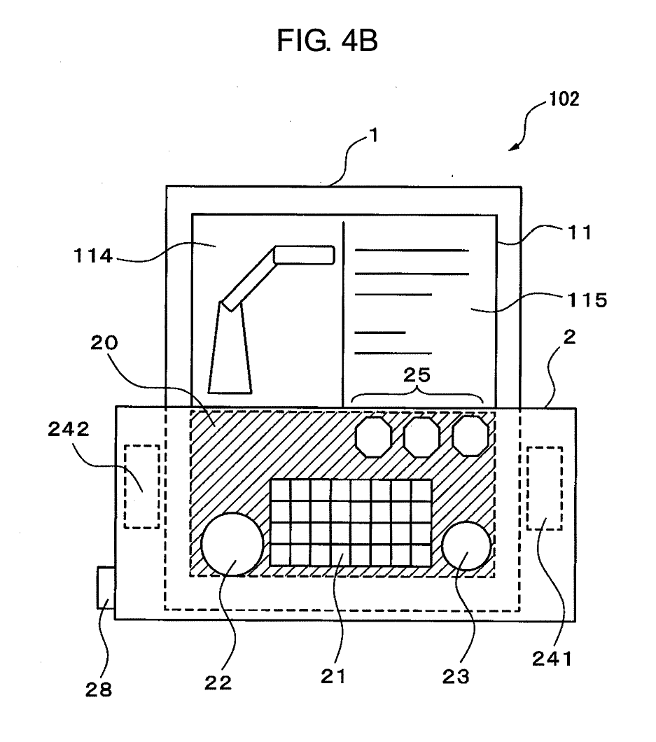

FIG. 4A illustrates a plan view of the machine operation panel 102 before the operation terminal 1 is integrated with the external device 2, and FIG. 4B illustrates a plan view of the machine operation panel 102 after the operation terminal 1 is integrated with the external device 2. As illustrated in FIG. 4A, it is assumed that three screens 111 to 113 are displayed on the touch panel 11 of the operation terminal 1 before the operation terminal 1 is integrated with the external device 2. For example, description is given for a case where the first screen 111 displays a state of the machine such as a robot, etc., a second screen 112 displays an application program, etc., and a third screen 113 displays a temperature of the control device, etc.

As illustrated in FIG. 4B, when the operation terminal 1 is integrated with the external device 2 such that a part of the display region of the display device of the operation terminal 1 is covered by the external device 2, the display switching device 12 switches the screen of the display device of the touch panel 11 to the screen for machine operation. For example, the first screen 111 displaying the state, etc., of the machine such as a robot, etc., is reduced and displayed like a fourth screen 114, and a fifth screen 115, such as a parameter input screen, dedicated to the operation panel can be newly displayed.

A region of the display region of the touch panel 11, except for the region 20 covered by the external device 2, can be visually identified from the outside. In the embodiment illustrated in FIG. 4B, the fourth screen 114 and the fifth screen 115 can be visually identified, but a range in which both of the screens are displayed can be set by the operator touching the touch panel 11. Alternatively, when the operation terminal 1 is integrated with the external device 2, the region that can be visually identified may be determined by detecting a region covered by the external device 2. Alternatively, in a case where the size of the operation terminal 1 to be connected is already known, information about a position of the active display region may be previously stored in the storage device 14 (see FIG. 3).

As in the machine operation panel according to the second embodiment, operability can be improved by causing the display device of the touch panel 11 to display a dedicated screen for machine operation when the operation terminal 1 is connected to the external device 2.

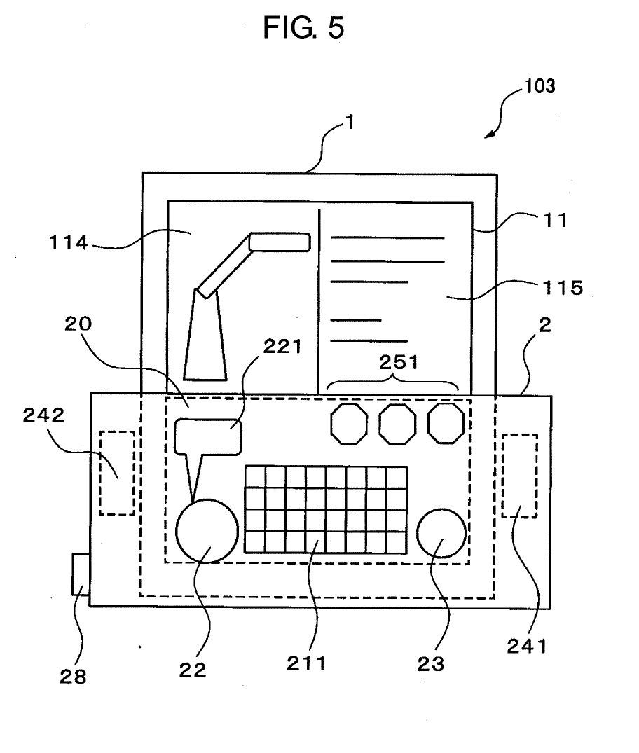

Next, a machine operation panel according to a third embodiment is described. FIG. 5 illustrates a plan view of a machine operation panel 103 according to the third embodiment. The machine operation panel 103 according to the third embodiment is different from the machine operation panel 101 according to the first embodiment in that the external device 2 is transparent in a region where the display region of the touch panel 11 and an input device 211 overlap and the input device 211 includes transparent keys. Since the other configuration of the machine operation panel 103 according to the third embodiment is similar to that of the machine operation panel 101 according to the first embodiment, a detailed description thereof is omitted.

A transparent input device 211 of the external device 2 is a keyboard including transparent keys. Further, the external device 2 is transparent in a region of the external device 2 where the display region of the touch panel 11 of the operation terminal 1 and the input device 211 overlap. Moreover, the operation terminal 1 performs key display on a screen corresponding to the transparent input device 211 in the display region of the display device of the touch panel 11. A button of the transparent input device 211 provided in the external device 2 is caused to operate together with the screen of the display device of the touch panel 11 in the operation terminal 1 disposed below the button. In other words, each key of the transparent input device 211 and positional information on the touch panel 11 are previously associated with each other. With this configuration, when each key of the transparent input device 211 is pressed, a same operation as that when the key display, which is displayed on the touch panel 11, corresponding to the pressed key is directly touched can be performed.

In the machine operation panel according to the third embodiment, the key display is displayed on the screen of the display device of the touch panel 11 in the operation terminal 1, so that arrangement of keys can be freely set and language can be switched among English, Japanese, Chinese, etc.

Further, by making the external device 2 in the region 20 covering the display region of the touch panel 11 to be transparent, the operation terminal 1 may cause at least one of a state of control of the machine or help information to be displayed in a display region corresponding to the transparent region of the external device 2 in the display region of the touch panel 11. For example, by providing a transparent portion in the region 20 of the external device 2 covering the display region of the operation terminal 1, lamps 251 indicating the state of control of the machine can be displayed in the display region of the display device of the touch panel 11 and thus be visually identified through the transparent portion. For example, a blue lamp may be displayed in a case where the machine is operating normally. Further, a yellow lamp may be displayed in a case where an abnormal condition of the machine occurs. Moreover, a red lamp may be displayed in a case where the machine stops. This configuration can eliminate concerns about life of the lamps and save time for replacing the lamps.

By providing a transparent portion of the external device 2 around the manual pulse generating device 22 and the emergency stop button 23, a description 221 of each apparatus can be displayed around each apparatus and be thus visually identified. This configuration allows help information such as “PRESS THIS BUTTON” to be displayed during operation of the machine operation panel, and allows the operation of the machine operation panel to be correctly executed.

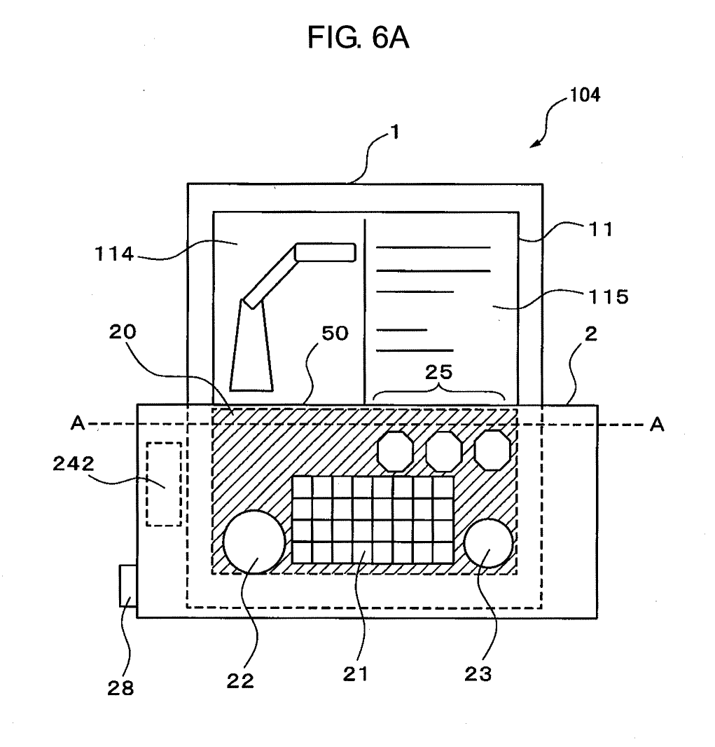

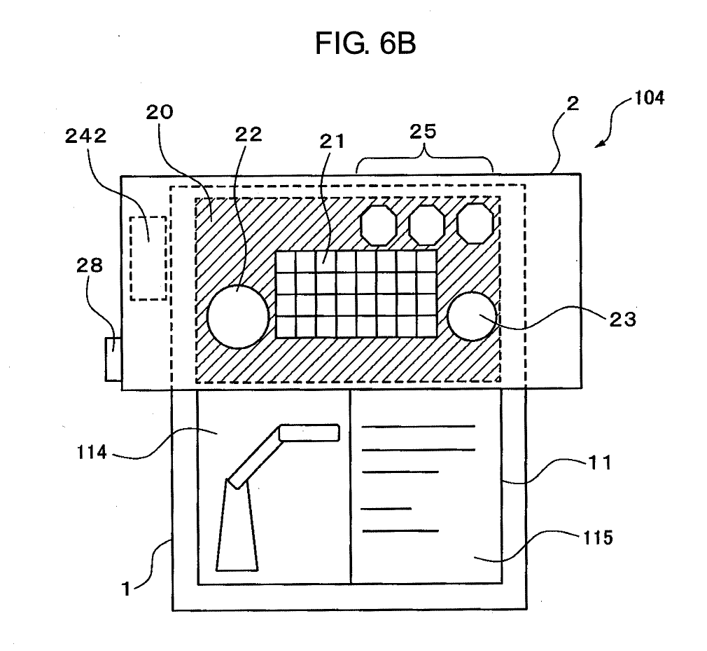

Next, a machine operation panel according to a fourth embodiment is described. FIGS. 6A and 6B illustrate plan views of a machine operation panel 104 according to the fourth embodiment. The machine operation panel 104 according to the fourth embodiment is different from the machine operation panel 101 according to the first embodiment in that the external device 2 has a hollow portion into which the operation terminal 1 can be inserted from both directions and the operation terminal 1 switches display according to an insertion direction. Since the other configuration of the machine operation panel 104 according to the fourth embodiment is similar to that of the machine operation panel 101 according to the first embodiment, a detailed description thereof is omitted.

FIG. 6A illustrates a state where the operation terminal 1 is inserted downward from above the external device 2. FIG. 6B illustrates a state where the operation terminal 1 is inserted upward from below the external device 2. In FIG. 6A, since a lower display region of the operation terminal 1 is covered by the external device 2, a screen used for operation of the control device, such as the fourth screen 114 and the fifth screen 115, is displayed on the upper side of the operation terminal 1.

On the other hand, in FIG. 6B, since an upper display region of the operation terminal 1 is covered by the external device 2, the fourth screen 114 and the fifth screen 115 are displayed on the lower side of the operation terminal 1.

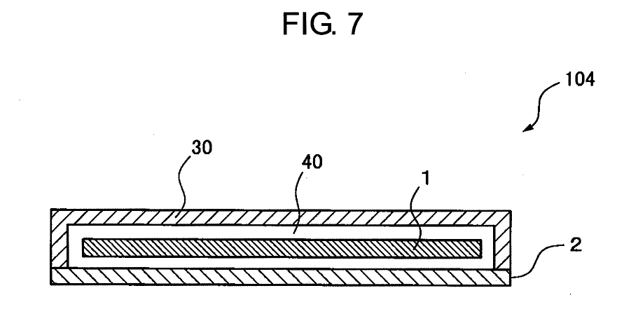

A hollow portion into which the operation terminal 1 can be inserted from both up and down directions is provided in the rear surface of the external device 2. FIG. 7 illustrates a cross-sectional view of the machine operation panel 104 according to the fourth embodiment taken along line A-A in FIG. 6A. A rear surface portion 30 is provided in the rear surface of the external device 2, and a hollow portion 40 is provided between the external device 2 and the rear surface portion 30. After the operation terminal 1 is inserted into the hollow portion 40 of the external device 2, the operation terminal 1 is preferably fixed to the external device 2 for fall prevention. For example, a hinge can be used as a mechanism for fall prevention.

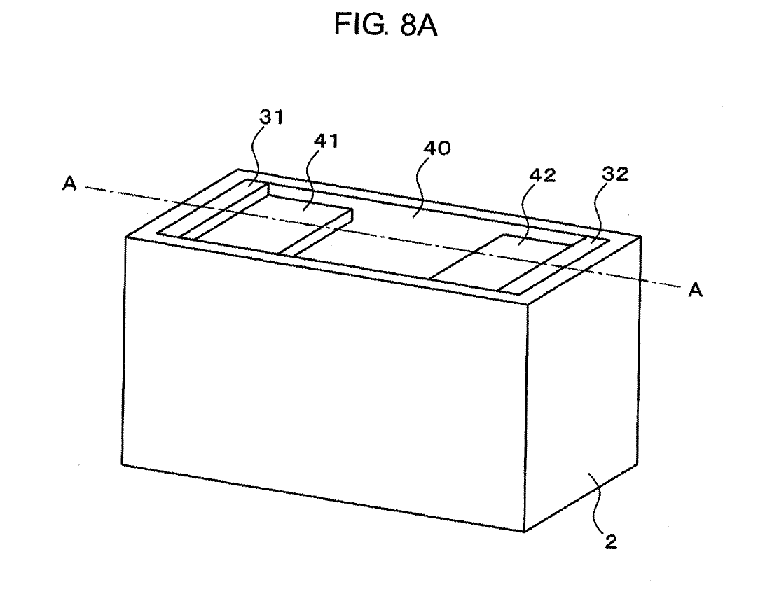

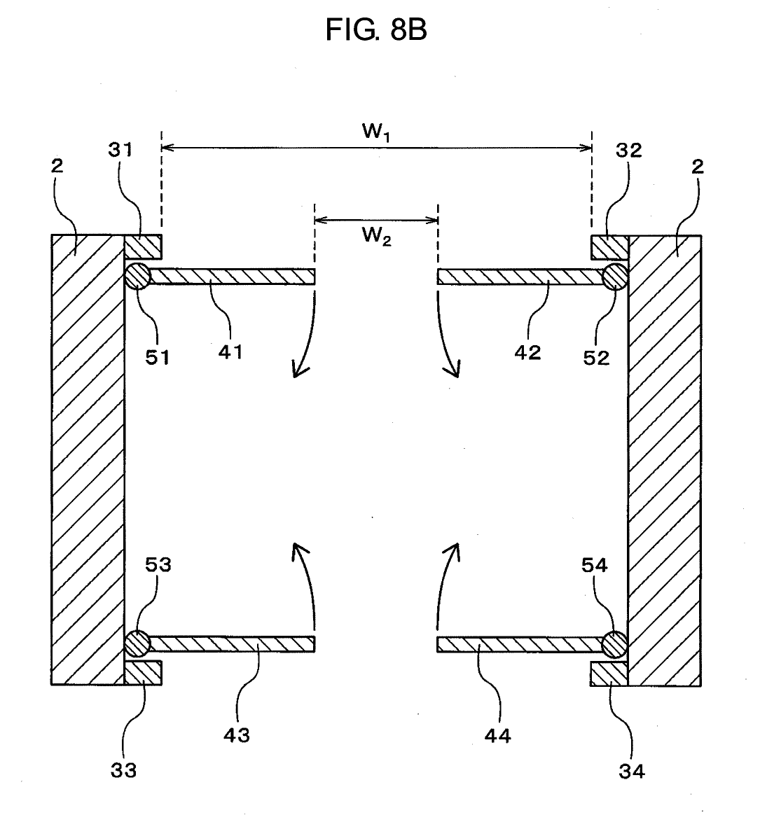

FIG. 8A illustrates a perspective view of the machine operation panel according to the fourth embodiment and a hollow external device including hinges.

FIG. 8B illustrates a cross-sectional view of the hollow external device including the hinges taken along line A-A in FIG. 8A. As illustrated in FIGS. 8A and 8B, hinges 41 to 44 are provided in the hollow portion 40 of the external device 2. The hinges 41 to 44 can rotate about support portions 51 to 54 in directions of arrows illustrated in FIG. 8B, and the operation terminal can be inserted from both the up and down directions.

For example, when the operation terminal is inserted from above in FIG. 8B, the hinges 41 and 42 rotate in the directions of the arrows. Moreover, the inserted operation terminal is supported by the hinges 43 and 44. At this time, stoppers 33 and 34 are provided for preventing the hinges 43 and 44 from rotating in directions opposite to the directions of the arrows.

Similarly, when the operation terminal is inserted from below in FIG. 8B, the hinges 43 and 44 rotate in the directions of the arrows. Moreover, the inserted operation terminal is supported by the hinges 41 and 42. At this time, stoppers 31 and 32 are provided for preventing the hinges 41 and 42 from rotating in directions opposite to the directions of the arrows.

A width W of the operation terminal inserted into the hollow portion 40 of the external device 2 needs to satisfy a condition (W₂<W<W₁) where the width W is smaller than a gap W₁ between the two stoppers (31 and 32, or 33 and 34) and larger than a gap W₂ between the two hinges (41 and 42, or 43 and 44). This configuration allows the operation terminal to be easily inserted into the hollow portion 40 of the external device 2 and to be held.

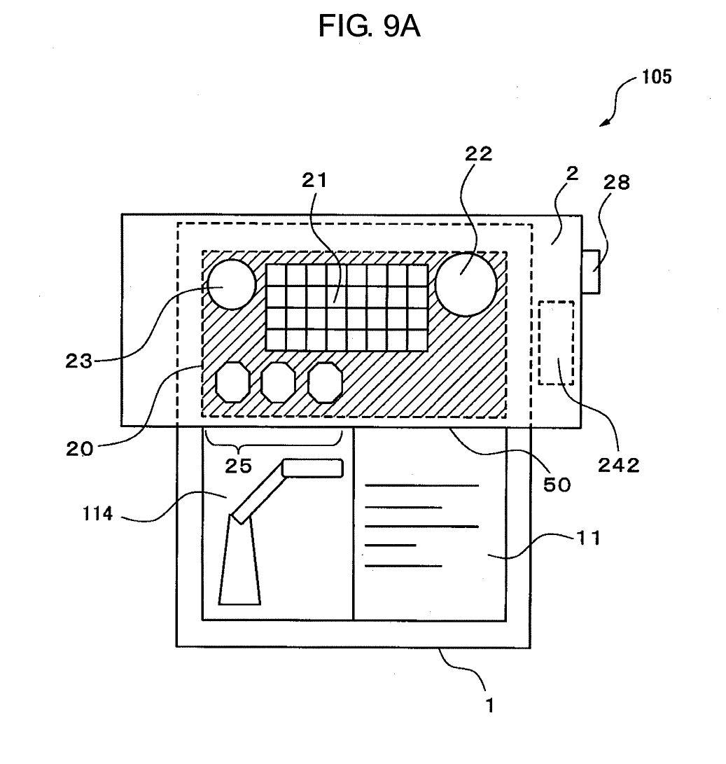

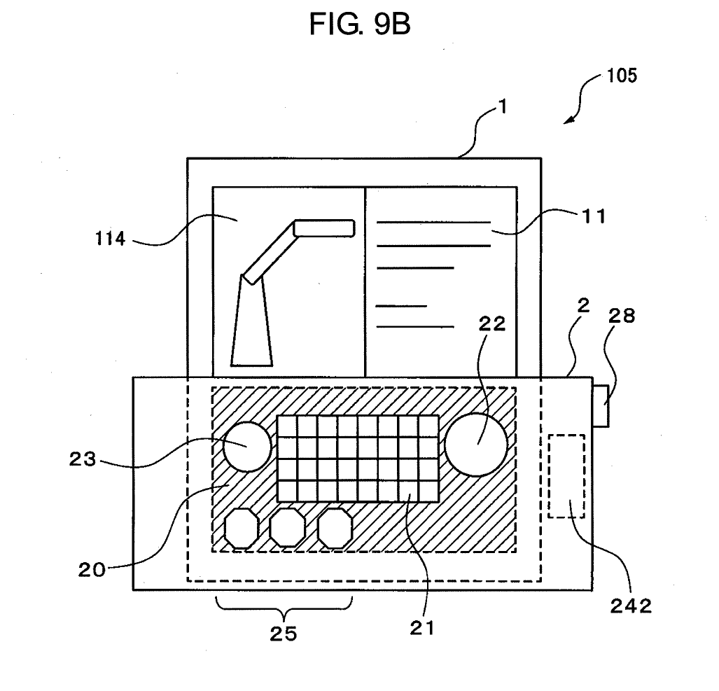

Next, a machine operation panel according to a fifth embodiment is described. FIGS. 9A and 9B illustrate plan views of a machine operation panel 105 according to the fifth embodiment. The machine operation panel 105 according to the fifth embodiment is different from the machine operation panel 101 according to the first embodiment in that the external device 2 has an insertion portion into which the operation terminal 1 is inserted on one side in a longitudinal direction of the external device 2, and that the operation terminal 1 includes a gravitational sensor that rotates the display region of the display device of the touch panel (11) 180 degrees when the machine operation panel 105 is rotated 180 degrees with the operation terminal 1 inserted into the external device 2. Since the other configuration of the machine operation panel 105 according to the fifth embodiment is similar to that of the machine operation panel 101 according to the first embodiment, a detailed description thereof is omitted.

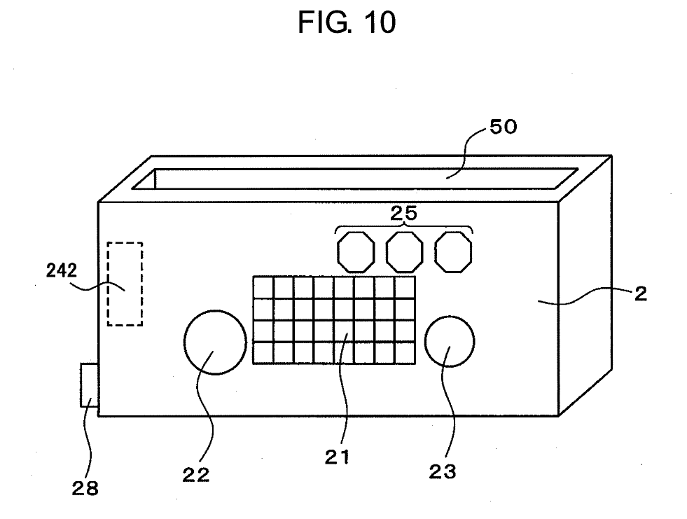

FIG. 9A illustrates a state where an insertion portion 50 into which the operation terminal 1 is inserted is provided on the upper side in the longitudinal direction of the external device 2, and the machine operation panel 105 is rotated 180 degrees with the operation terminal 1 inserted into the external device 2. FIG. 10 illustrates a perspective view of the external device 2 forming the machine operation panel 105 according to the fifth embodiment. The insertion portion 50 is provided on the upper side in the longitudinal direction of the external device 2. An insertion portion is not formed on the lower side in the longitudinal direction of the external device 2, and an end portion has a closed structure. In FIG. 9A, the insertion portion 50 is provided on the lower side in the longitudinal direction of the external device 2, but the insertion portion 50 is provided on the upper side in the longitudinal direction of the external device 2 as illustrated in FIG. 6A before the machine operation panel 105 is rotated 180 degrees. When the machine operation panel 105 is simply rotated 180 degrees with the operation terminal 1 inserted into the external device 2, the fourth screen 114 and the fifth screen 115 may be flipped vertically and cannot be correctly visually identified. However, according to this embodiment, the operation terminal 1 rotates the display region of the display device of the touch panel (11) 180 degrees, so that the fourth screen 114 and the fifth screen 115 can be correctly visually identified without being flipped vertically, as illustrated in FIG. 9A. The operation terminal 1 may include a gravitational sensor that detects the up-down direction of the display device in order to rotate the display region of the display device of the touch panel (11) 180 degrees.

Further, in the description above, a case of the screen display following when the external device 2 connected to the operation terminal 1 rotates through 180 degrees is described, but this embodiment is not restrictive. In other words, when the external device 2 is rotated 180 degrees without the operation terminal 1 inserted into the external device 2, and then the operation terminal 1 is inserted into the external device 2, the display can follow the rotation by rotating the display region of the touch panel (11) 180 degrees.

FIG. 9B illustrates a state where an insertion portion into which the operation terminal 1 is inserted is provided on the lower side in the longitudinal direction of the external device 2, and the machine operation panel 105 is rotated 180 degrees with the operation terminal 1 inserted into the external device 2. Note that FIG. 6B illustrates the state before the external device 2 with the operation terminal 1 inserted thereinto is rotated. When the machine operation panel 105 is simply rotated 180 degrees with the operation terminal 1 inserted into the external device 2, the fourth screen 114 and the fifth screen 115 may be flipped vertically and cannot be correctly visually identified. However, according to this embodiment, the operation terminal 1 rotates the display region of the display device of the touch panel (11) 180 degrees, so that the fourth screen 114 and the fifth screen 115 can be correctly visually identified, without being flipped vertically, as illustrated in FIG. 9B.

It is preferable that the region 20 covering the operation terminal 1 and the input device 21 of the external device 2 are made to be transparent and the key display displayed in the display region of the touch panel 11 can be visually identified. In this case, even in a case where the machine operation panel 105 is rotated 180 degrees, by rotating a direction of the keys displayed in the display region of the touch panel (11) 180 degrees, the display of the keys can be correctly visually identified from the transparent input device 21 and key input can be correctly performed.

Moreover, the region 20 covering the operation terminal 1 of the external device 2 may be made to be transparent, and switches 25 may be displayed in the display region of the touch panel 11. In this way, the switches 25 can be disposed in a desired position of the external device 2 even in the case where the machine operation panel 105 is rotated 180 degrees.

Note that as illustrated in FIG. 6A, the enable switch 242 may be provided in at least one of side portions in a lateral direction of the external device 2. When the enable switch 242 is provided only on the left side, by rotating the machine operation panel (105) 180 degrees, the enable switch 242 can be disposed on the right side as illustrated in FIG. 9. In this way, the enable switch can be disposed on a desired side according to a dominant hand of the operator.

In the description above, the embodiment in which the operation terminal 1 is combined with the external device 2 to be used as the machine operation panel is illustrated, but it is preferable that the external device 2 can operate the control device also in isolation. The external device 2 according to one aspect of the present disclosure is an external device connected to a control device of a machine and configured to operate the control device. The external device 2 includes: the emergency stop button 23 configured to stop the control device; the enable switch (241, 242) active during teaching operation of the machine; and the input device 21 configured to input data to an operation terminal. The operation terminal is attached such that at least a part of the display region of the operation terminal is covered. At least a part of the input device 21 is provided in a region overlapping the display region.

Examples of the operation by the external device 2 in isolation include an operation that can be achieved without a display screen of an operation terminal, such as jog feeding while looking at a robot. In a case where the external device 2 includes the lamps 25, the lamps 25 can preferably light up also during operation in isolation. The enable switch (241, 242), the emergency stop button 23, and the manual pulse generating device 22 can be preferably operated also in the case of the external device in isolation.

In the machine operation panel according to one aspect of the present disclosure, excellent operability by an operator can be maintained without increasing the size of the machine operation panel even in a case where an operation terminal such as a tablet terminal is used as a mobile communication apparatus of the machine operation panel.

What is claimed is:

1. A machine operation panel connected to a control device of a machine and configured to operate the control device, the machine operation panel comprising:
an operation terminal that includes a touch panel for display and input of information and is configured to be portable; and
an external device that includes an emergency stop button, an enable switch, and an input device configured to input data to the operation terminal, the external device being connected to the operation terminal,
wherein the operation terminal is attached to the external device such that at least a part of a display region of the touch panel is covered, and
wherein at least a part of the input device is provided in a region overlapping the display region.

2. The machine operation panel according to claim 1,
wherein the external device further includes a manual pulse generating device.

3. The machine operation panel according to claim 1,
wherein the operation terminal further includes a display switching device configured to switch a screen of the touch panel to a screen for machine operation upon detection of connection with the external device.

4. The machine operation panel according to claim 1,
wherein the external device is transparent in a region where the display region of the touch panel and the input device overlap, and the input device includes a transparent key.

5. The machine operation panel according to claim 4,
wherein the external device is transparent in a region covering the display region of the touch panel, and
wherein the operation terminal causes at least one of a state of control of the machine or help information to be displayed in a display region corresponding to the transparent region of the external device in the display region of the touch panel.

6. The machine operation panel according to claim 1,
wherein the external device has a hollow portion into which the operation terminal is configured to be inserted from both directions, and
wherein the operation terminal switches display according to an insertion direction.

7. The machine operation panel according to claim 1,
wherein the external device has an insertion portion into which the operation terminal is inserted on one side in a longitudinal direction of the external device, and
wherein the operation terminal includes a gravitational sensor configured to rotate the display region of the touch panel 180 degrees when the machine operation panel is rotated 180 degrees with the operation terminal inserted into the external device.

8. The machine operation panel according to claim 7,
wherein the machine operation panel has a function of rotating the display region of the touch panel 180 degrees when the external device is rotated 180 degrees without the operation terminal inserted into the external device and then the operation terminal is inserted into the external device.

9. The machine operation panel according to claim 6,
wherein the enable switch is provided in at least one of side portions in a lateral direction of the external device.

10. An external device connected to a control device of a machine and configured to operate the control device, the external device comprising:
an emergency stop button configured to stop the control device;
an enable switch active during teaching operation of the machine; and
an input device configured to input data to an operation terminal,
wherein the operation terminal is attached such that at least a part of a display region of the operation terminal is covered, and
wherein at least a part of the input device is provided in a region overlapping the display region.

11. The machine operation panel according to claim 2,
wherein at least one of the emergency stop button, the enable switch, or the manual pulse generating device can be operated in the external device in isolation.
